(19) United States
(12) Patent Application Publication
(10) Pub. No.: US 2014/0168708 A1
(43) Pub. Date: Jun. 19, 2014

(54) COMBINING PRINT JOBS

(71) Applicant: Yen Hsiang Chew, Georgetown (MY)

(72) Inventor: Yen Hsiang Chew, Georgetown (MY)

(21) Appl. No.: 13/719,651

(22) Filed: Dec. 19, 2012

(51) Int. Cl. G06K 15/02

(52) U.S. Cl. CPC G06K 15/1848
USPC 358/1.18

(57) ABSTRACT

A method and system for combining print jobs is described herein. The method includes loading a print surface containing a first print job and obtaining a second print job. The first print job and the second print job may be combined into a composite file, wherein the composite file is used to adjust the first print job and the second print job.

### TECHNICAL FIELD

The present invention relates generally to printing embodiments. More specifically, the present invention relates to combining print jobs.

### BACKGROUND ART

Printing devices do not provide any mechanisms for a user to print on previously printed surfaces. In order to print a new print job on a surface containing another print job printed prior to the current print job, the printing surface is manually sorted, aligned, and fed into the printing device. Minor misalignments between the current print job and the prior print job create a combined print job that is poor quality and generally unacceptable for use.

### BRIEF DESCRIPTION OF THE DRAWINGS

FIG. 1 is a block diagram of a computing device that may be used in accordance with embodiments;

FIG. 2 is a process flow diagram illustrating a method for combining print jobs, in accordance with embodiments;

FIG. 3 is a process flow diagram illustrating a method for overlaying print jobs, in accordance with embodiments;

FIG. 4 is a process flow diagram illustrating a method for printing on recycled paper, in accordance with embodiments;

FIG. 5 is a block diagram showing tangible, non-transitory computer-readable media that stores code for combining print jobs, in accordance with embodiments;

FIG. 6 is a block diagram of an exemplary system for combining print jobs, in accordance with embodiments; and

FIG. 7 is a schematic of a small form factor device in which the system of FIG. 6 may be embodied, in accordance with embodiments.

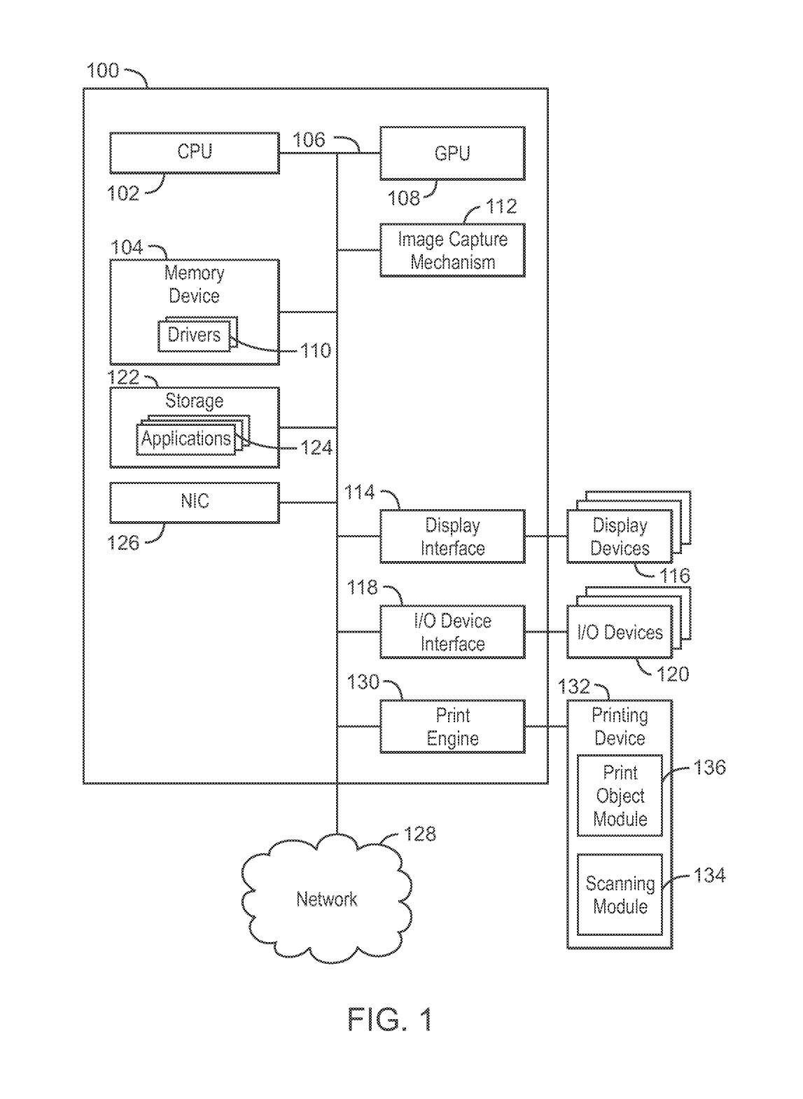

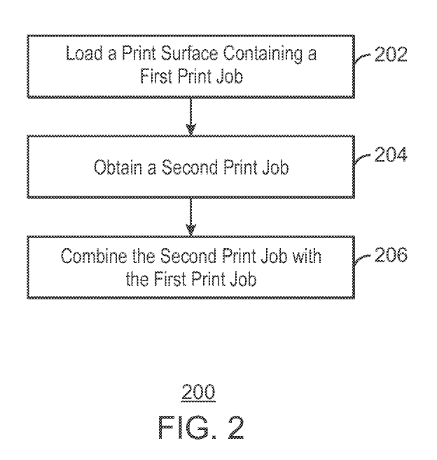

The same numbers are used throughout the disclosure and the figures to reference like components and features. Numbers in the 100 series refer to features originally found in FIG. 1; numbers in the 200 series refer to features originally found in FIG. 2; and so on

### DESCRIPTION OF THE EMBODIMENTS

As discussed above, printing devices generally do not provide any mechanisms to combine a current print job on a printing surface that contains a prior print job. As used herein, a print job refers to any printed output of a printing device. Accordingly, a print job includes, but is not limited to, an image, text, line drawings, and abstract designs. Moreover, as used herein a print surface refers to any material where a print job can be applied. Thus, a print job includes, but is not limited to, paper, fabric, plastic, ceramic surfaces, and the like.

According to embodiments, a first print job may be loaded from a print surface. A second print job may be obtained from a queue, and the first print job and the second print job may be merged. The combined first print job and the second print job may be adjusted before the second print job is applied to the print surface containing the first print job. In this manner, the combined first print job and the second print job may be properly aligned when rendered on the print surface

In the following description and claims, the terms “coupled” and “connected” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the inventions. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of a computing device 100 that may be used in accordance with embodiments. The computing device 100 may be, for example, a laptop computer, desktop computer, tablet computer, mobile device, or server, among others. The computing device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the computing device 100 may include more than one CPU 102. The instructions that are executed by the CPU 102 may be used to combine print jobs in accordance with embodiments.

The computing device 100 may also include a graphics processing unit (GPU) 108. As shown, the CPU 102 may be coupled through the bus 106 to the GPU 108. The GPU 108 may be configured to perform any number of graphics operations within the computing device 100. For example, the GPU 108 may be configured to render or manipulate graphics images, graphics frames, videos, or the like, to be displayed to a user of the computing device 100. In some embodiments, the GPU 108 includes a number of graphics engines, wherein each graphics engine is configured to perform specific graphics tasks, or to execute specific types of workloads. In embodiments, the method for combining print jobs described herein is performed by at least one of the CPU, the GPU, or any combination thereof.

The memory device 104 can include random access memory (RAM), read only memory (ROM), flash memory, or any other suitable memory systems. For example, the memory device 104 may include dynamic random access memory (DRAM). The memory device 104 may include drivers 110 that are configured to execute the instructions for combining print jobs. The driver 110 may be software, an application program, application code, or the like.

The computing device 100 includes an image capture mechanism 112. In embodiments, the image capture mechanism 112 is a camera, stereoscopic camera, scanner, infrared sensor, or the like. The image capture mechanism 112 is used to capture image information. The image capture mechanism may employ various sensors to capture image information, such as an image sensor, a charge-coupled device (CCD) image sensor, a complementary metal-oxide-semiconductor (CMOS) image sensor, a system on chip (SOC) image sensor, an image sensor with photosensitive thin film transistors, or any combination thereof in embodiments, the driver 110 may combine an image from the image capture mechanism 112 with a print job that has been previously printed.

The CPU 102 may be linked through the bus 106 to a display interface 114 configured to connect the computing device 100 to a display device 116. The display device 116 may include a display screen that is a built-in component of the computing device 100. The display device 116 may also include a computer monitor, television, or projector, among others, that is externally connected to the computing device 100.

The CPU 102 may also be connected through the bus 106 to an input/output (I/O) device interface 118 configured to connect the computing device 100 to one or more I/O devices 120. The I/O devices 120 may include, for example, a keyboard and a pointing device, wherein the pointing device may include a touchpad or a touchscreen, among others. The I/O devices 120 may be built-in components of the computing device 100, or may be devices that are externally connected to the computing device 100.

The computing device also includes a storage device 122. The storage device 122 is a physical memory such as a hard drive, an optical drive, a thumbdrive, an array of drives, or any combinations thereof. The storage device 122 may also include remote storage drives. The storage device 122 includes any number of applications 124 that are configured to run on the computing device 100. The applications 124 may be used to combine the print jobs.

In examples, an application 124 may be used to alter images already present on the print surface with the addition of images or text. Further, in examples, an application 124 may combine text that was printed with a previous print job with new text. The combined text may be rendered by printing the additional text onto the print surface that contains the old text.

The computing device 100 may also include a network interface controller (NIC) 126 may be configured to connect the computing device 100 through the bus 106 to a network 128. The network 128 may be a wide area network (WAN), local area network (LAN), or the Internet, among others.

In some embodiments, an application 124 can send the new text or images to add to the print surface to a print engine 130. The print engine 130 that can send the new text or images to a printing device 132. The print engine may also receive the text or images already present on the print surface from the printing device. Accordingly, the printing device 132 may include a scanning module 134. The printing device 132 may be a printer, fax machine, and or any other printing devices that can print the additional text or images onto the printing surface using a print object module 136. In embodiments, the print engine 130 may send data to the printing device 132 across the network 128.

In embodiments, a first print job may be adjusted based on a second printed document before printing the first print job over the second printed document. The printed document may be scanned into a viewable file format, and then combined with a new print job to produce a composite file. A user may use the composite file to make adjustments to the first print job before overlaying the first print job on the printed document.

Additionally, in embodiments, the scanning module 134 scans a print surface from a paper tray that is connected to the printing device 132. The paper tray may be a special tray reserved for storing previously printed documents for recycling or reprinting. The paper tray may also be directly connected to a scanning device that includes the scanning module 134. Although the present techniques are described using paper trays, such as a printer input tray and a printer output tray, any printer input or printer output may be used in the present techniques. Further, the scanning device may be coupled with the printing device 132 or the scanning device can be integrated with the printing device 132.

The block diagram of FIG. 1 is not intended to indicate that the computing device 100 is to include all of the components shown in FIG. 1. Further, the computing device 100 may include any number of additional components not shown in FIG. 1, depending on the details of the specific implementation.

FIG. 2 is a process flow diagram illustrating a method 200 for combining print jobs in accordance with embodiments. In embodiments, the method 200 is performed by one or more of the print engine 130, the printing device 132, the image capture mechanism 112 as described in FIG. 1, or any combination thereof. At block 202, a print surface may be loaded that contains a first print job. In embodiments, the first print job may be printed on the print surface with the intention of adding an additional print job to the print surface at a later time. For example, a user may print a first image onto a print surface. After the first image is printed, the user may add a second print job to the print surface that contains the first print job.

Additionally, in embodiments, the first print job may be a print job that was printed on the print surface, but was later deemed to be printed in error or no longer needed. For example, an image or text may be print onto a piece of paper for immediate use, but the paper may be discarded after it has been used. In such a scenario, the paper that has been discarded may be recycled. A user may want to conserve paper by printing another print job in a section of recycled paper that contains enough free space to print the another print job.

At block 204, a second print job is obtained. In embodiments, the second print job may be stored in a print queue. The second print job may be an additional image or text that is to be added to the first print job in an integrated manner. The second print job may also be an additional text or image that is printed onto any free space on the print surface.

At block 206, the second print job is combined with the first print job into a composite file. A user may analyze the composite file and make alignment and size adjustments to the first print job and the second print job. The composite file may be analyzed using the printing device 132 or a computing device 100 that is coupled with the printing device 132. The user may then print the composite file. The printing device 132 will print the second print job onto the print surface that contains the first print job. The printing device 132 will use the composite file during printing to ensure the proper alignments and size adjustments are used when printing to the print surface. In this manner, the composite file may be accurately applied to the print surface, without any misalignments or erroneous printing. Furthermore, the composite file enables the user to align and overlay a new document over a previously printed document, while preventing misalignment of the first print job and the second print job, as well as permanent damage to the final printed composite document. Further, a user may automatically choose to print a document on recycled paper without having to first sort and choose a blank non-printed page or a blank non-printed section of recycled paper to be printed over.

In embodiments, the print surface may be a sheet of paper on which contains a previously printed first print job. The sheet of paper may be referred to as a printed document. The printing device may be a printer that is able to scan the previously printed first print job. When scanning the previously printed first print job, the printer may automatically load and scan the paper from the printer's paper tray. After scanning, the previously printed first print job may be converted into a displayable format, such as an image or text document. The first print job may then be combined with a second print job to form a new composite file that is displayed to a user. The display may be integrated with the printer device, or separate from the printer.

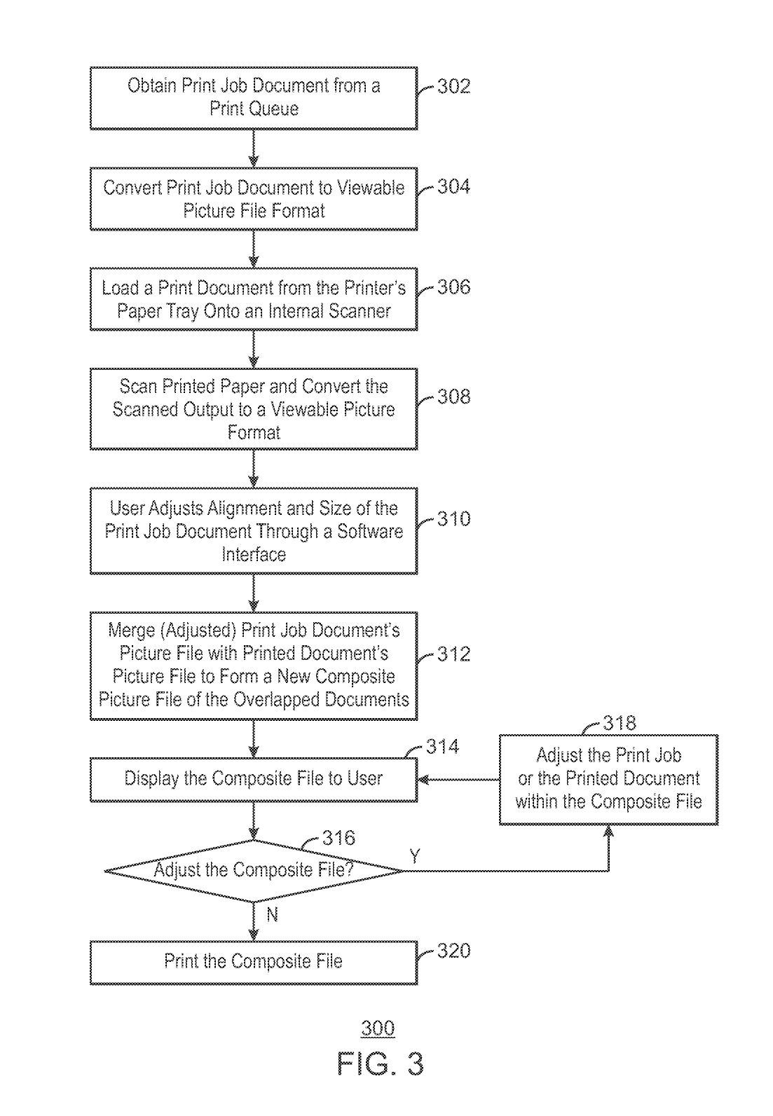

FIG. 3 is a process flow diagram 300 illustrating a method for overlaying print jobs, in accordance with embodiments. At block 302, a print job may be obtained from a print queue. The print job may be a selection of text or an image that will be added to another print job. In embodiments, the print queue is stored in a memory device. The memory device may be present on a CPU or a printer. The print queue may be a specialized print queue that is used to store all print jobs where a user can make alignments and size adjustments to a composite file before printing the composite file. Furthermore, in embodiments, a user may be authenticated before obtaining a print job from the print queue in order to combine the print job with another print job and make any adjustments. The user may be authenticated using an image viewer and software present on the printer. Additionally, the user may be authenticated using an image viewer and software present on a computing device.

At block 304, the print job may be converted to a first viewable picture file. The picture file format may be any format that can be displayed to a user. At block 306, a printed document may be loaded from the printer's paper tray onto a scanner. In embodiments, the scanner is a component of the printer. At block 308, the printed document is scanned and converted to a second viewable picture file. At block 310, a user can adjust the alignment and the size of the print job by manipulating the first viewable picture file. The adjustments may be done using a software interface.

At block 312, the first viewable picture file of the print job that has been adjusted is merged with the second viewable picture file of the scanned printed document to form a composite viewable picture file. Accordingly, the composite viewable picture file contains the print job obtained from the print queue that has been adjusted overlapping the printed document that has been scanned. At block 314, the composite file may be displayed to the user.

At block 316, it is determined if the composite viewable picture file should be adjusted. For example, the composite file may be adjusted when the print job obtained from the print queue does not properly overlap the printed document that has been scanned and may be adjusted. If the composite viewable picture file should be adjusted, process flow continues to block 318. If the composite file should not be adjusted, process flow continues to block 320.

At block 318, the printed document that has been scanned, the print job obtained from the print queue that has been adjusted, and any combination thereof is adjusted. The print job obtained from the print queue that has been adjusted may be adjusted again, after being merged with the scanned printed document. The adjustment of the print job may be done by adjusting the viewable picture format of the document. In embodiments, the adjustment of the viewable picture file of the document will cause the print job to be sized aligned to the printed document's actual size and physical alignment in the printer's paper tray. Additionally, in embodiments, edits may be made to the print job within the merged composite file. Furthermore, in embodiments; the adjusted composited viewable picture file may be stored on a computing device or printed on a new piece of blank paper or print surface without having to print over the original printed document.

At block 320, the composite file may be printed. When printing the composite file, the adjusted print job obtained from the print queue is printed onto the original printed document as adjusted by the user. The printed document that has been scanned and adjusted is not printed onto the document, as it is already present on the sheet of paper. In embodiments, the composite file may be sent to another print queue prior to printing. Additionally, the printer may also keep track of which previously printed print job is currently located in its paper tray for printing.

Accordingly, a user is able to place a printed document in a printer's paper tray. The paper tray may be an ordinary paper tray such as an A4 paper tray. In embodiments, the paper tray may be a special tray reserved for storing previously printed documents for recycling or reprinting. The printer software interface may provide an application programming interface (API) for user to select overlap printing. If the overlap printing option is selected, the printer will obtain the user specified print document from a print queue. The print document may be converted to a viewable picture file, such as a bitmap format, JPEG format, TIFF format, or any other picture file format. A printed document or hard copy may be loaded from the printer's special tray onto an internal scanner. The printed document may then be scanned and the scanned output may be converted to a viewable picture file. The scanned printed document may be temporarily place in a location within the printer that is reserved for printing the next overlapped document. The user specified print document's picture file may be merged or overlapped with the scanned printed document's picture file to form a new composite picture file of the overlapped documents. The composite picture file may be displayed to the user and the user may adjust the alignment and size of the print document through a software interface. The composite picture filed may be printed with or without adjustments. In embodiments, other print jobs within a print queue may be performed first while user is adjusting the alignment and size of an composite file. In such a scenario, the printer is able to keep track of which hard copy printed document to use in its printer tray for printing the composite document when the user decides to print.

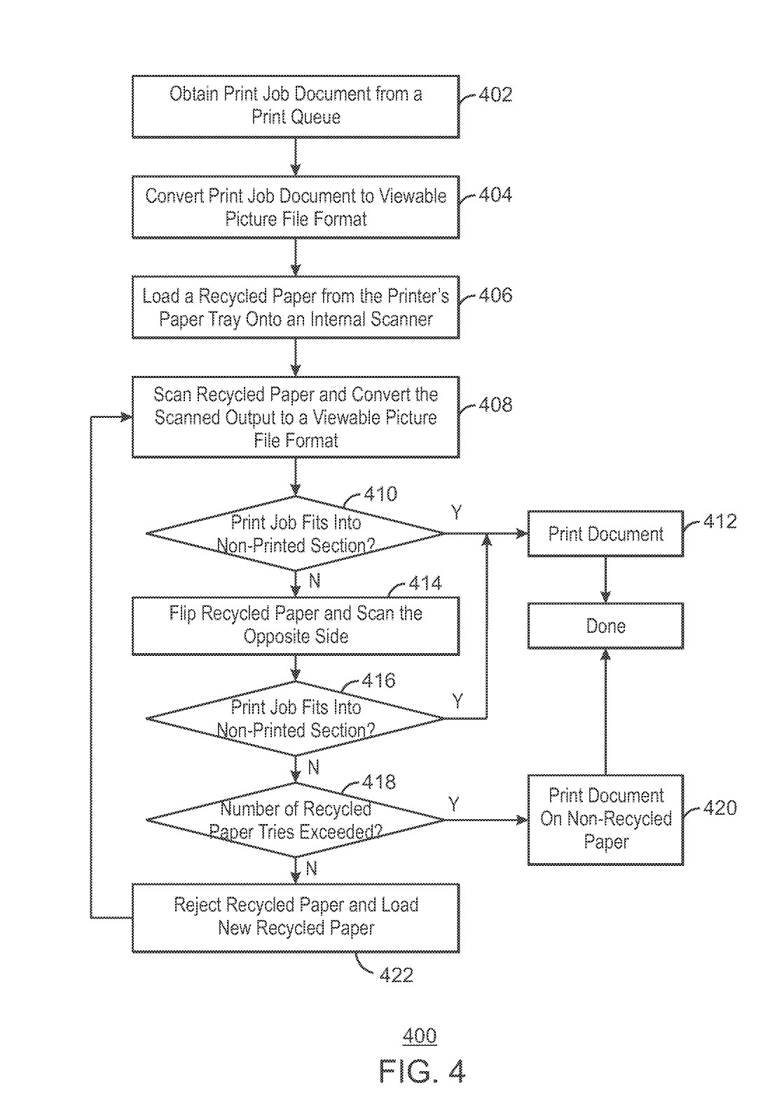

FIG. 4 is a process flow diagram 400 illustrating a method for printing on recycled paper, in accordance with embodiments. At block 402, a print job may be obtained from a print queue. The print job may be a selection of text or an image that will be added to another print job. In embodiments, the print queue is stored in a memory device, and the memory device may be present on a CPU or a printer.

At block 404, the print job may be converted to a first viewable picture file. The picture file format includes any format that can be displayed to a user. At block 406, a recycled paper may be loaded from the printer's paper tray onto a scanner. In embodiments, the scanner is a component of the printer. The recycled paper includes images and text that are not to be integrated into the final printed document. Rather, the recycled paper includes some empty space where additional text or images can be printed. Accordingly, using the recycled paper allows paper that was previously discarded to be reused.

At block 408, the recycled paper is scanned and converted to a second viewable picture file. At block 410, it is determined if the print job fits into a non-printed section of the recycled paper. A non-printed section of the recycled paper is a portion of the recycled paper that has no text or images. In embodiments, a non-printed section of the recycled paper may be a portion of the recycled paper that contains lightly printed text or images, thus printing the print job over that portion of the recycled paper would be acceptable as the print job would still be legible. If the print job fits into a non-printed section of the recycled paper, process flow continues to block 412. If the print job does not fit into a non-printed section of the recycled paper, process flow continues to block 414.

At block 412, the print job is printed onto the recycled paper. In embodiments, when the print job is printed onto the recycled paper, the printer may also print strike-throughs or cross-hatching atop of the extra text or images that are already present on the recycled paper. At block 414, the recycled paper is flipped and the opposite side of the recycled paper is scanned. At block 416, it is determined if the print job fits into a non-printed section of the opposite side of the recycled paper. If the print job fits into a non-printed section of the opposite side of the recycled paper, process flow continues to block 412 where the print job is printed onto the recycled paper. If the print job does not fit into a non-printed section of the opposite side of the recycled paper, process flow continues to block 418.

At block 418, it is determined if the number of recycled paper tries have been exceeded. The number of recycled paper tries is a pre-determined number of times the printer will attempt to print the print job on recycled paper. The number of recycled paper tries may be preset by using software loaded on the printer, or by printer drivers located on a computing device. If the number of recycled paper tries have been exceeded, then process flow continues to block 420. If the number of recycled paper tries have not been exceeded, then process flow continues to block 422.

At block 420, the print job is printed on paper that is not recycled. At block 422, the currently loaded recycled paper is rejected and another recycled paper is loaded. In embodiments, the rejected paper is stored in another printer tray. Process flow then returns to block 408, where the next piece of recycled paper is scanned. Accordingly, several pieces of recycled paper may be scanned in order to find a recycled paper that has enough non-printed space available to print the selected print job.

The process flow diagram of FIGS. 2, 3, and 4 are not intended to indicate that the blocks of the methods 200, 300, and 400 are to be executed in any particular order, or that all of the blocks are to be included in every case. Further, any number of additional blocks may be included within the methods 200, 300, and 400, depending on the details of the specific implementation. The methods 200, 300, and 400 may also be combined. Additionally, while the methods described herein include a printer, any printing device may be used.

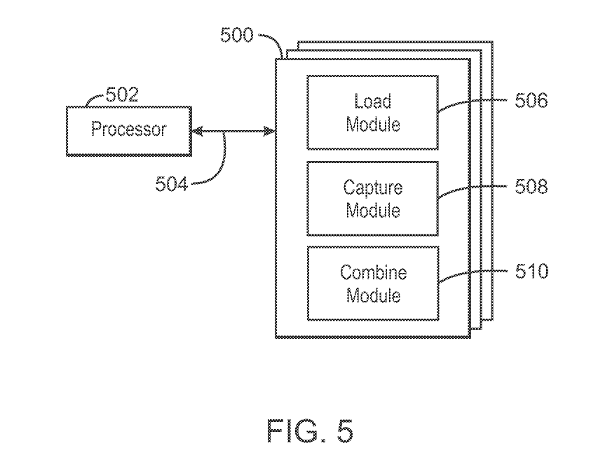

FIG. 5 is a block diagram showing tangible, non-transitory computer-readable media 500 that stores code for combining print jobs, in accordance with embodiments. The tangible, non-transitory computer-readable media 500 may be accessed by a processor 502 over a computer bus 504. Furthermore, the tangible, non-transitory computer-readable media 500 may include code configured to direct the processor 502 to perform the methods described herein.

The various software components discussed herein may be stored on the tangible, non-transitory computer-readable media 500, as indicated in FIG. 5. For example, a load module 506 may be configured to load a print surface containing a first print job. A capture module 508 may be configured to obtain a second print job. A combine module 510 may be configured to combine the second print job with the first print job into a composite file.

The block diagram of FIG. 5 is not intended to indicate that the tangible, non-transitory computer-readable media 500 is to include all of the components shown in FIG. 5. Further, the tangible, non-transitory computer-readable media 500 may include any number of additional components not shown in FIG. 5, depending on the details of the specific implementation.

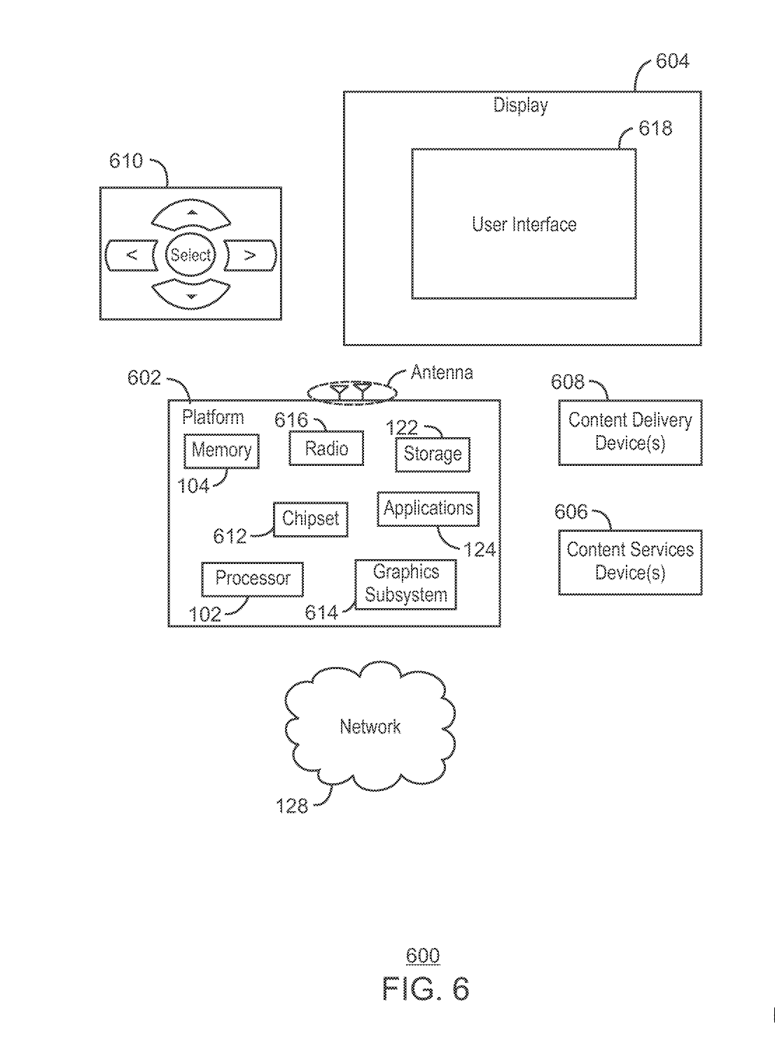

FIG. 6 is a block diagram of an exemplary system 600 for combining print jobs, in accordance with embodiments. Like numbered items are as described with respect to FIG. 1. In some embodiments, the system 600 is a media system. In addition, the system 600 may be incorporated into a personal computer (PC), laptop computer, ultra-laptop computer, server computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile Internet device (MID), messaging device, data communication device, a printing device, an embedded device or the like.

In various embodiments, the system 600 comprises a platform 602 coupled to a display 604. The platform 602 may receive content from a content device, such as content services device(s) 606 or content delivery device(s) 608, or other similar content sources. A navigation controller 610 including one or more navigation features may be used to interact with, for example, the platform 602 and/or the display 604. Each of these components is described in more detail below.

The platform 602 may include any combination of a chipset 612, a central processing unit (CPU) 102, a memory device 104, a storage device 122, a graphics subsystem 614, applications 124, and a radio 616. The chipset 612 may provide intercommunication among the CPU 102, the memory device 104, the storage device 122, the graphics subsystem 614, the applications 124, and the radio 616. For example, the chipset 612 may include a storage adapter (not shown) capable of providing intercommunication with the storage device 122.

The CPU 102 may be implemented as Complex Instruction Set Computer (CISC) or Reduced Instruction Set Computer (RISC) processors, x86 instruction set compatible processors, multi-core, or any other microprocessor or central processing unit (CPU). In some embodiments, the CPU 102 includes multi-core processor(s), multi-core mobile processor(s), or the like.

The memory device 104 may be implemented as a volatile memory device such as, but not limited to, a Random Access Memory (RAM), Dynamic Random Access Memory (DRAM), or Static RAM (SRAM). The storage device 122 may be implemented as a non-volatile storage device such as, but not limited to, a magnetic disk drive, optical disk drive, tape drive, solid state drive, an internal storage device, an attached storage device, flash memory, battery backed-up SDRAM (synchronous DRAM), and/or a network accessible storage device. In some embodiments, the storage device 122 includes technology to increase the storage performance enhanced protection for valuable digital media when multiple hard drives are included, for example.

The graphics subsystem 614 may perform processing of images such as still or video for display. The graphics subsystem 614 may include a graphics processing unit (GPU), such as the GPU 108, or a visual processing unit (VPU), for example. An analog or digital interface may be used to communicatively couple the graphics subsystem 614 and the display 604. For example, the interface may be any of a High-Definition Multimedia Interface, DisplayPort, wireless HDMI, and/or wireless HD compliant techniques. The graphics subsystem 614 may be integrated into the CPU 102 or the chipset 612. Alternatively, the graphics subsystem 614 may be a stand-alone card communicatively coupled to the chipset 612.

The graphics and/or video processing techniques described herein may be implemented in various hardware architectures. For example, graphics and/or video functionality may be integrated within the chipset 612. Alternatively, a discrete graphics and/or video processor may be used. As still another embodiment, the graphics and/or video functions may be implemented by a general purpose processor, including a multi-core processor. In a further embodiment, the functions may be implemented in a consumer electronics device.

The radio 616 may include one or more radios capable of transmitting and receiving signals using various suitable wireless communications techniques. Such techniques may involve communications across one or more wireless networks. Exemplary wireless networks include wireless local area networks (WLANs), wireless personal area networks (WPANs), wireless metropolitan area network (WMANs), cellular networks, satellite networks, or the like. In communicating across such networks, the radio 616 may operate in accordance with one or more applicable standards in any version.

The display 604 may include any television type monitor or display. For example, the display 604 may include a computer display screen, touch screen display, video monitor, television, or the like. The display 604 may be digital and/or analog. In some embodiments, the display 604 is a holographic display. Also, the display 604 may be a transparent surface that may receive a visual projection. Such projections may convey various forms of information, images, objects, or the like. For example, such projections may be a visual overlay for a mobile augmented reality (MAR) application. Under the control of one or more applications 124, the platform 602 may display a user interface 618 on the display 604.

The content services device(s) 606 may be hosted by any national, international, or independent service and, thus, may be accessible to the platform 602 via the Internet, for example. The content services device(s) 606 may be coupled to the platform 602 and/or to the display 604. The platform 602 and/or the content services device(s) 606 may be coupled to a network 128 to communicate (e.g., send and/or receive) media information to and from the network 128. The content delivery device(s) 608 also may be coupled to the platform 602 and/or to the display 604.

The content services device(s) 606 may include a cable television box, personal computer, network, telephone, or Internet-enabled device capable of delivering digital information. In addition, the content services device(s) 606 may include any other similar devices capable of unidirectionally or bidirectionally communicating content between content providers and the platform 602 or the display 604, via the network 128 or directly. It will be appreciated that the content may be communicated unidirectionally and/or bidirectionally to and from any one of the components in the system 600 and a content provider via the network 128. Examples of content may include any media information including, for example, video, music, medical and gaming information, and so forth.

The content services device(s) 606 may receive content such as cable television programming including media information, digital information, or other content. Examples of content providers may include any cable or satellite television or radio or Internet content providers, among others.

In some embodiments, the platform 602 receives control signals from the navigation controller 610, which includes one or more navigation features. The navigation features of the navigation controller 610 may be used to interact with the user interface 618, for example. The navigation controller 610 may be a pointing device or a touchscreen device that may be a computer hardware component (specifically human interface device) that allows a user to input spatial (e.g., continuous and multi-dimensional) data into a computer. Many systems such as graphical user interfaces (GUI), and televisions and monitors allow the user to control and provide data to the computer or television using physical gestures. Physical gestures include but are not limited to facial expressions, facial movements, movement of various limbs, body movements, body language or any combinations thereof. Such physical gestures can be recognized and translated into commands or instructions.

Movements of the navigation features of the navigation controller 610 may be echoed on the display 604 by movements of a pointer, cursor, focus ring, or other visual indicators displayed on the display 604. For example, under the control of the applications 124, the navigation features located on the navigation controller 610 may be mapped to virtual navigation features displayed on the user interface 618. In some embodiments, the navigation controller 610 may not be a separate component but, rather, may be integrated into the platform 602 and/or the display 604.

The system 600 may include drivers (not shown) that include technology to enable users to instantly turn on and off the platform 602 with the touch of a button after initial boot-up, when enabled, for example. Program logic may allow the platform 602 to stream content to media adaptors or other content services device(s) 606 or content delivery device(s) 608 when the platform is turned “off” In addition, the chipset 612 may include hardware and/or software support for 5.1 surround sound audio and/or high definition 7.1 surround sound audio, for example. The drivers may include a graphics driver for integrated graphics platforms. In some embodiments, the graphics driver includes a peripheral component interconnect express (PCIe) graphics card.

In various embodiments, any one or more of the components shown in the system 600 may be integrated. For example, the platform 602 and the content services device(s) 606 may be integrated; the platform 602 and the content delivery device(s) 608 may be integrated; or the platform 602, the content services device(s) 606, and the content delivery device(s) 608 may be integrated. In some embodiments, the platform 602 and the display 604 are an integrated unit. The display 604 and the content service device(s) 606 may be integrated, or the display 604 and the content delivery device(s) 608 may be integrated, for example.

The system 600 may be implemented as a wireless system or a wired system. When implemented as a wireless system, the system 600 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum. When implemented as a wired system, the system 600 may include components and interfaces suitable for communicating over wired communications media, such as input/output (I/O) adapters, physical connectors to connect the I/O adapter with a corresponding wired communications medium, a network interface card (NIC), disc controller, video controller, audio controller, or the like. Examples of wired communications media may include a wire, cable, metal leads, printed circuit board (PCB), backplane, switch fabric, semiconductor material, twisted-pair wire, co-axial cable, fiber optics, or the like.

The platform 602 may establish one or more logical or physical channels to communicate information. The information may include media information and control information. Media information may refer to any data representing content meant for a user. Examples of content may include, for example, data from a voice conversation, videoconference, streaming video, electronic mail (email) message, voice mail message, alphanumeric symbols, graphics, image, video, text, and the like. Data from a voice conversation may be, for example, speech information, silence periods, background noise, comfort noise, tones, and the like. Control information may refer to any data representing commands, instructions or control words meant for an automated system. For example, control information may be used to route media information through a system, or instruct a node to process the media information in a pre-determined manner. The embodiments, however, are not limited to the elements or the context shown or described in FIG. 6.

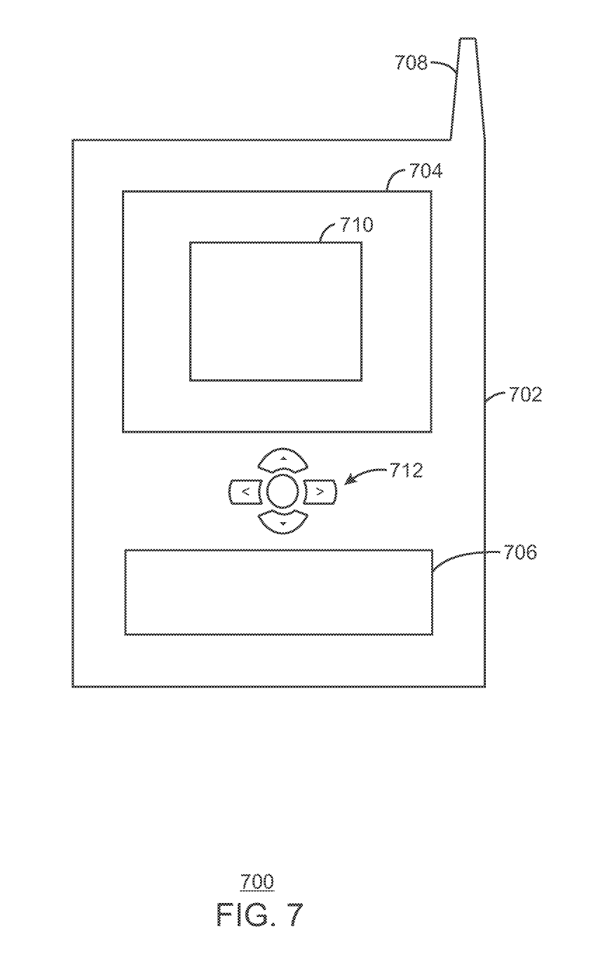

FIG. 7 is a schematic of a small form factor device 700 in which the system 600 of FIG. 6 may be embodied, in accordance with embodiments. Like numbered items are as described with respect to FIG. 6. In some embodiments, for example, the device 700 is implemented as a mobile computing device having wireless capabilities. A mobile computing device may refer to any device having a processing system and a mobile power source or supply, such as one or more batteries, for example.

As described above, examples of a mobile computing device may include a personal computer (PC), laptop computer, ultra-laptop computer, server computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and the like.

An example of a mobile computing device may also include a computer that is arranged to be worn by a person, such as a wrist computer, finger computer, ring computer, eyeglass computer, belt-clip computer, arm-band computer, shoe computer, clothing computer, or any other suitable type of wearable computer. For example, the mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wired or wireless mobile computing devices as well.

As shown in FIG. 7, the device 700 may include a housing 702, a display 704, an input/output (I/O) device 706, and an antenna 708. The device 700 may also include navigation features 712. The display 704 may include any suitable display 710 unit for displaying information appropriate for a mobile computing device. The I/O device 706 may include any suitable I/O device for entering information into a mobile computing device. For example, the I/O device 706 may include an alphanumeric keyboard, a numeric keypad, a touch pad, input keys, buttons, switches, rocker switches, microphones, speakers, a voice recognition device and software, or the like. Information may also be entered into the device 700 by way of microphone. Such information may be digitized by a voice recognition device

### Example 1

A method for combining print jobs is described herein. The method includes loading a print surface containing a first print job, obtaining a second print job, and combining the second print job with the first print job into a composite file. The composite file is used to adjust the first print job and the second print job. Loading the print surface includes obtaining the print surface from an input tray, scanning the print surface, and converting the print surface to a viewable file format. Obtaining a print job from a print queue includes converting the print job to a viewable file format. The print job is adjusted by adjusting the viewable file format. Further, combining the second print job with the first print job includes adjusting an alignment; a size, or an orientation of at least one of the print jobs, a printed document, or any combination thereof. Additionally, the composite file is displayed to a user, and the composite file is stored or printed. The second print job is printed over the printed surface containing the first print job based on the adjusted alignment, size, or orientation of the combined print jobs in the composite file.

The print surface may be recycled paper. The recycled paper may be scanned to an output file, the output file may be converted to a viewable picture format, and the composite file may be adjusted so that the print job fits within a non-printed section of the recycled paper. A first side of the recycled paper and a second side of the recycled paper may be scanned to an output file, and the output file may be converted to a viewable picture format. The side of the recycled paper that contains a non-printed section large enough for the print job may be selected and another recycled paper may be selected to combine with the print job if the print job does not fit within a non-printed section on the first side of the recycled paper and the second side of the recycled paper. The print job may be printed on clean paper when a number of recycled paper attempts have been exceeded.

### Example 2

A printing device to print a combined print job, including a print object module is described herein. The print object module is configured to enable an authenticated user to retrieve a print job from a print queue, combine the print job with a printed document, and change an alignment, a size, or an orientation of the combined print job and printed document. The print object module may keep track of the printed document to be combined with the print job while the combined print job and printed document is adjusted. The print job may also be stored in a specialized print queue, and the printed document may be recycled paper. The printing device may include a paper tray that is dedicated to storing printed documents. A user may adjust the combined print job and printed document by adjusting the alignment, adjusting the size, rotating, or flipping at least one of the print job, the printed document, or any combination thereof.

### Example 3

An apparatus is described herein. The apparatus includes a paper input tray, a paper output tray, a scanner, and a controller. The controller obtains a print job from a print queue, loads a printed document, merges the print job with the printed document into a composite file, and adjust the print job and printed document using the composite file. Obtaining a print job from a print queue includes converting the print job to a viewable picture file. Loading the printed document includes scanning the printed document and converting the printed document to a viewable picture file. Furthermore, combining the print job with the printed document includes adjusting an alignment, a size, or an orientation of at least one of the print job, the printed document, or any combination thereof. The composite file may be rendered on a display for viewing, and the composite file may be stored or sent to a print device for printing. Additionally, the print job may be printed over the printed document based on the adjusted alignment, size, or orientation of the combined print job and printed document in the composite file. The printed document may also be recycled paper. Additionally, the scanner may scan the printed document from the paper input, the paper output tray, or any combinations thereof.

### Example 4

At least one machine readable medium is described herein. The machine readable medium includes instructions stored therein that, in response to being executed on a computing device, cause the computing device to obtain a print job from a print queue, load a printed document, combine the print job with the printed document into a composite file, and adjust the print job and printed document using the composite file.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method for combining print jobs, comprising:
loading a print surface containing a first print job;
obtaining a second print job;
combining the second print job with the first print job into a composite file, wherein the composite file is used to adjust the first print job and the second print job.

2. The method of claim 1, wherein loading the print surface comprises:
obtaining the print surface from an input tray;
scanning the print surface; and
converting the print surface to a viewable file format.

3. The method of claim 1, wherein obtaining a print job from a print queue comprises converting the print job to a viewable file format.

4. The method of claim 3, wherein the print job is adjusted by adjusting the viewable file format.

5. The method of claim 1, wherein combining the second print job with the first print job comprises adjusting an alignment, a size, or an orientation of at least one of the print jobs, a printed document, or any combination thereof.

6. The method of claim 1, comprising wherein the composite file is displayed to a user.

7. The method of claim 1, wherein the composite file is stored or printed.

8. The method of claim 1, wherein the second print job is printed over the printed surface containing the first print job based on the adjusted alignment, size, or orientation of the combined print jobs in the composite file.

9. The method of claim 1, wherein the print surface is recycled paper.

10. The method of claim 9, comprising:
scanning the recycled paper to an output file;
converting the output file to a viewable picture format; and
adjusting the composite file so that the print job fits within a non-printed section of the recycled paper.

11. The method of claim 9, comprising:
scanning a first side of the recycled paper and a second side of the recycled paper to an output file;
converting the output file to a viewable picture format;
selecting the side of the recycled paper that contains a non-printed section large enough for the print job; and
obtaining another recycled paper to combine with the print job if the print job does not fit within a non-printed section on the first side of the recycled paper and the second side of the recycled paper.

12. The method of claim 9, comprising:
printing the print job on clean paper when a number of recycled paper attempts have been exceeded.

13. A printing device to print a combined print job, comprising a print object module configured to:
enable an authenticated user to retrieve a print job from a print queue;
combine the print job with a printed document; and
change an alignment, a size, or an orientation of the combined print job and printed document.

14. The printing device of claim 13, wherein the print object module keeps track of the printed document to be combined with the print job while the combined print job and printed document is adjusted.

15. The printing device of claim 13, wherein the print job is stored in a specialized print queue.

16. The printing device of claim 13, wherein the printed document is recycled paper.

17. The printing device of claim 13, wherein the printing device includes a paper tray that is dedicated to storing printed documents.

18. The printing device of claim 13, wherein a user adjusts the combined print job and printed document by adjusting the alignment, adjusting the size, rotating, or flipping at least one of the print job, the printed document, or any combination thereof.

19. An apparatus, comprising:
a scanner; and
a controller that obtains a print job from a print queue, loads a printed document, merges the print job with the printed document into a composite file, and adjusts the print job and printed document using the composite file.

20. The apparatus of claim 19, wherein obtaining a print job from a print queue comprises converting the print job to a viewable picture file.

21. The apparatus of claim 19, wherein loading the printed document comprises;
scanning the printed document using the scanner; and
converting the printed document to a viewable picture file.

22. The apparatus of claim 19, wherein combining the print job with the printed document comprises adjusting an alignment, a size, or an orientation of at least one of the print job, the printed document, or any combination thereof.

23. The apparatus of claim 19, comprising wherein the composite file is rendered on a display for viewing.

24. The apparatus of claim 19, wherein the composite file is stored or sent to a print device for printing.

25. The apparatus of claim 19, wherein the print job is printed over the printed document based on the adjusted alignment, size, or orientation of the combined print job and printed document in the composite file.

26. The apparatus of claim 19, wherein the printed document is recycled paper.

27. The apparatus of claim 19, wherein the scanner scans the printed document from the paper input, the paper output, or any combinations thereof.

28. At least one machine readable medium having instructions stored therein that, in response to being executed on a computing device, cause the computing device to:
obtain a print job from a print queue;
load a printed document; and
combine the print job with the printed document into a composite file; and
adjust the print job and printed document using the composite file.
